(19) United States
(12) Patent Application Publication
(10) Pub. No.: US 2014/0103804 A1
(43) Pub. Date: Apr. 17, 2014

(54) POWER DISTRIBUTION SYSTEM AND METHOD FOR LED LIGHTING

(71) Applicants: Siarhei Zhdanau, Mississauga (CA); Vladimir Grigorik, Mississauga (CA)

(72) Inventors: Siarhei Zhdanau, Mississauga (CA); Vladimir Grigorik, Mississauga (CA)

(21) Appl. No.: 13/840,494

(22) Filed: Mar. 15, 2013

Related U.S. Application Data
(60) Provisional application No. 61/612,741, filed on Mar. 19, 2012.

(51) Int. Cl. H05B 33/08

(52) U.S. Cl. CPC H05B 33/0812
USPC 315/85

(57) ABSTRACT

There is disclosed an improved LED lighting system and method which limits current and employs a voltage significantly greater than line voltage in order to allow lighting circuits to be built with up to thousands of Watts fed from a sing power/data source. The present system and method allows exceptionally long lengths of LED lighting of 200 meters or more for large scale LED lighting applications such as the architectural delineation of skyscrapers and bridges.

### FIELD

This present disclosure relates generally to a power distribution system and method for light emitting diode (LED) lighting.

### BACKGROUND

Large scale controllable LED lighting applications such as lighting for architectural delineation for skyscrapers, bridges, airports and shopping malls and other mission critical applications require high system reliability, and long service life. Additionally, such applications desire small luminaire size and long luminaire run length from single power connection point.

However, existing power distribution systems for LED lighting suffer from limitations including limited life, larger luminaire dimensions, limited lighting length and limited system life.

What is needed is an improved power system and method for LED lighting which overcomes at least some of these limitations.

### SUMMARY

This present disclosure relates generally to an improved AC line supplied LED lighting power distribution system and method, in which the required power conversion components, specifically electromagnetic interference (EMI) filter, rectifier, and power factor corrector (PFC), are located remotely from luminaires, enabling smaller luminaire size, and keeping the advantages of the high voltage power distribution system.

Additionally, the disclosed power distribution current is limited to reasonable ranges in order to maintain desirably small physical dimensions. The disclosed power distribution system delivers sufficient total power by significantly increasing the system voltage above the peak input line voltage (e.g. 110 VAC in North America).

In an illustrative embodiment, which is not meant to be limiting, a system is designed around AWG 18 conductors with current limited to 10 A, and voltage at around 380 VDC to allow lighting circuits to be built with up to 3,800 W fed from a sing power/data source.

With the present system and method, LED lighting lengths of 200 meters or more may be configured providing exceptionally long runs of LED lighting for large scale LED lighting applications such as the architectural delineation for skyscrapers and bridges.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1A shows a schematic block diagram of a conventional AC LED lighting system with inboard power distribution

FIG. 1B shows a schematic block diagram of a conventional AC LED lighting system with low-voltage power distribution.

FIGS. 2A and 2B show an illustrative schematic block diagram of the disclosed power distribution system for LED lighting utilizing a power-data box in accordance with an embodiment.

FIGS. 3A and 3B show illustrative perspective views of one possible physical embodiment of the DC LED lighting system of FIGS. 2A and 2B.

FIGS. 4A and 4B show illustrative plan views and perspective views of another possible physical embodiment of the DC LED lighting system of FIGS. 2A and 2B.

FIGS. 5A and 5B show illustrative plan views and perspective views of yet another possible physical embodiment of the DC LED lighting system of FIGS. 2A and 2B.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present disclosure relates generally to an improved power distribution system and method for LED lighting, especially for large scale LED lighting applications such as lighting for architectural delineation for skyscrapers, bridges, airports and shopping malls and the like.

Prior art technologies are based on two common approached to power distribution:
1. Low-voltage DC power distribution—power supply converting AC to low voltage DC is located remotely from luminaire. Each luminaire is powered by low voltage DC power.
2. Inboard luminaire power integration—power supply is integrated with luminaire, enabling high voltage distribution but large luminaire dimensions.

A low voltage DC distribution system is not suitable for lighting significant lengths due to electric current limitations, as specified by Class 2 electrical code. The LED lighting lengths, for example at 5 Watts/foot (1 foot=0.3048 meters) can be extended only 20 feet or so assuming 5 W/ft power consumption to stay within Class 2 specifications.

An inboard luminaire power system, where the AC/DC power supplies are integrated with LED luminaires, enables extended run lengths (e.g. 50-60 ft at 110 VAC, and 100 ft at 220 VAC), however the physical dimensions of luminaires are increased due to the presence of EMI, rectified and PFC power conversion components within the luminaire. Additionally, the overall system reliability is dictated by the shortest lifespan of inboard components. Typical embodiments of this approach rely on electrolytic capacitors which have an order of magnitude shorter lifespan than other components of the system. Also, the lighting run lengths remain capped because they are based on fixed input AC line voltage (110 VAC or 220 VAC depending on the geographical region).

The present system and method was developed by the inventors to address the issues of component size, while maintaining sufficient brightness over long lighting lengths. More particularly, the inventors proposed a power distribution system in which the required power conversion components, specifically EMI filter, rectifier, and PFC, are located remotely from luminaires, enabling smaller luminaire size, and keeping the advantages of the high voltage power distribution system.

Additionally, the inventors made a decision to limit the current to a suitable level in order to be able to use sufficiently small gauges of conductive wires, and by significantly increasing voltage over conventional household line voltages (e.g. 110 VAC in North America, and 220 VAC in Europe and other regions) to allow for adequate power.

As an illustrative example, which is not meant to be limiting, a system is designed around AWG 18 conductors with current limited to 10 Amps, and voltage at around 380 VDC to allow lighting circuits to be built with up to 3,800 W fed from a sing power/data source. With the present system and method, LED lighting lengths of 200 meters or more may be configured providing exceptionally long runs of LED lighting for large scale LED lighting applications such as the architectural delineation for skyscrapers and bridges. To generate the high voltages necessary, the present system and method utilizes a power-data box comprising a filter, bridge and a PFC as a power source, replacing multiple PFC modules in each lighting module with a single PFC provided in the power-data box.

Various illustrative embodiments are described with respect to the figures.

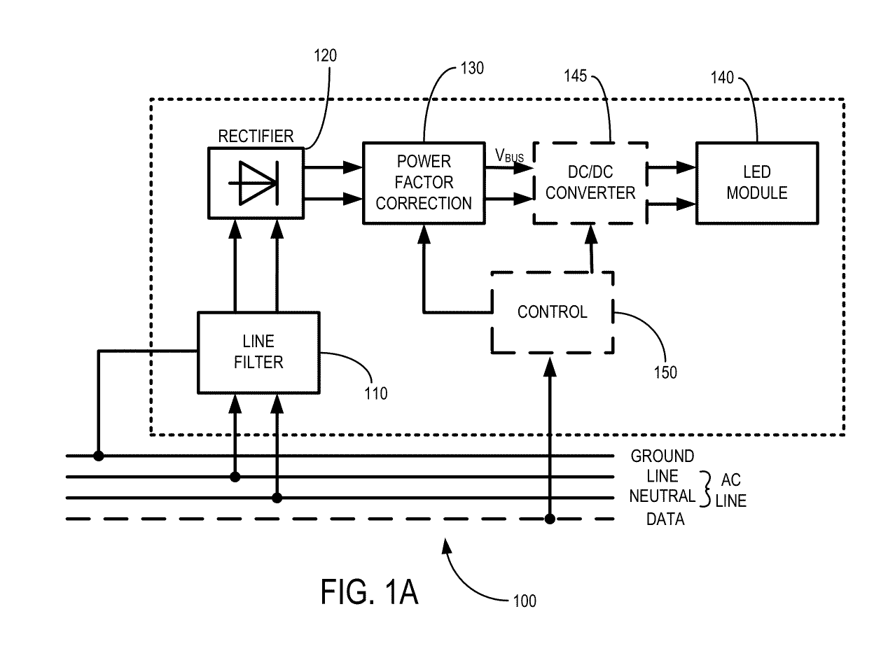

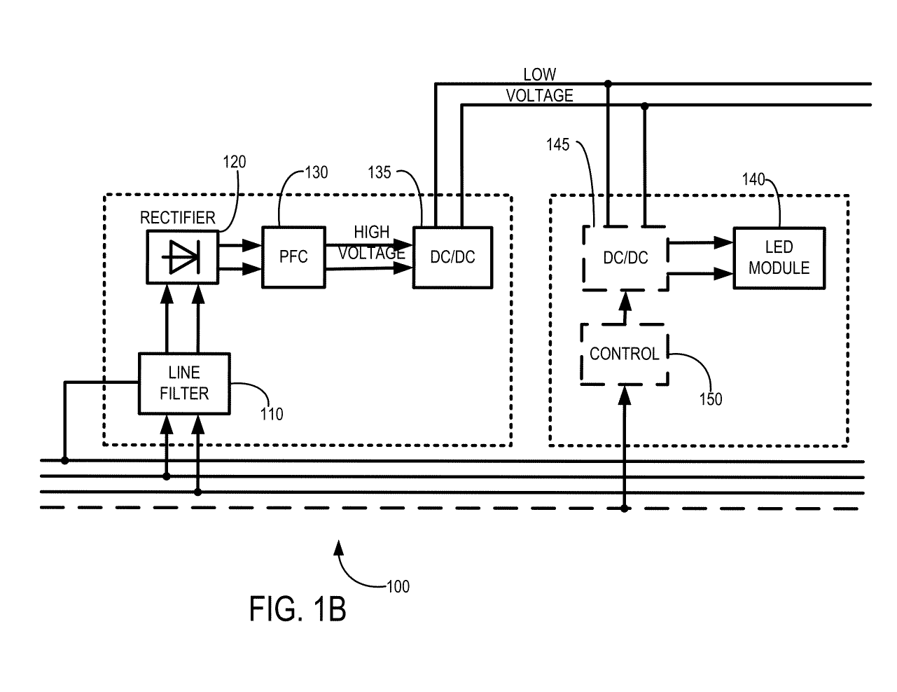

Referring to FIG. 1A, shown is a schematic block diagram of a conventional AC LED lighting system with inboard power distribution 100 including a line filter 110 connected to ground and to an AC line including line and neutral. The AC line provides a typical AC line voltage (e.g. 110 VAC in North America, 220 VAC in Europe and in other regions). The AC line voltage can also be supplied from 2 or 3 phase power systems. As shown, line filter 110 is operatively connected to a rectifier 120, which in turn is connected to a power factor correction (“PFC”) module 130. The rectifier 120 converts an input AC line voltage source to a DC voltage at value Vac*SQRT(2), where Vac is the root mean square value of the AC line voltage. PFC 130 provides power factor on the AC line close to 1.0 and its output voltage (for a boost type of PFC) is at least a few volts higher than DC voltage from the rectifier 130 (180 VDC at AC line voltage 110 VAC; 260 VDC at AC lien voltage 220 VAC and 430 VDC at universal AC lien voltage 70 VAC to 305 VAC). Notably, using any step-down type of PFC (for example buck, buck-boost, etc.) is a problem for red green blue (RGB) color changing types of LED luminaries for various reasons. A bus voltage Vbus from PFC 130 supplies LED module 140. An optional DC/DC driver 145 may be provided between PFC 130 and LED module 140 to down convert to a voltage suitable to the LED module 140. A control 150 is adapted to receive a data signal from the data line to control DC/DC driver 145 and/or PFC 130.

Referring to FIG. 1B, shown in a schematic block diagram of another conventional AC LED lighting system with low-voltage power distribution. As shown, line filter 110, rectifier 120 and PFC 130 supply a high voltage to a DC/DC converter 135 in a conventional power box. DC/DC converter 135 provides low voltage power to one or more luminaires, including a DC/DC driver 145, control 150, and an LED 140. The low voltage power provided to the one or more luminaires necessitates a correspondingly high current in order to drive the one or more luminaires at sufficient brightness. To handle the higher current, a thicker gauge wire is required in order to extend the length of the wires providing the low voltage power.

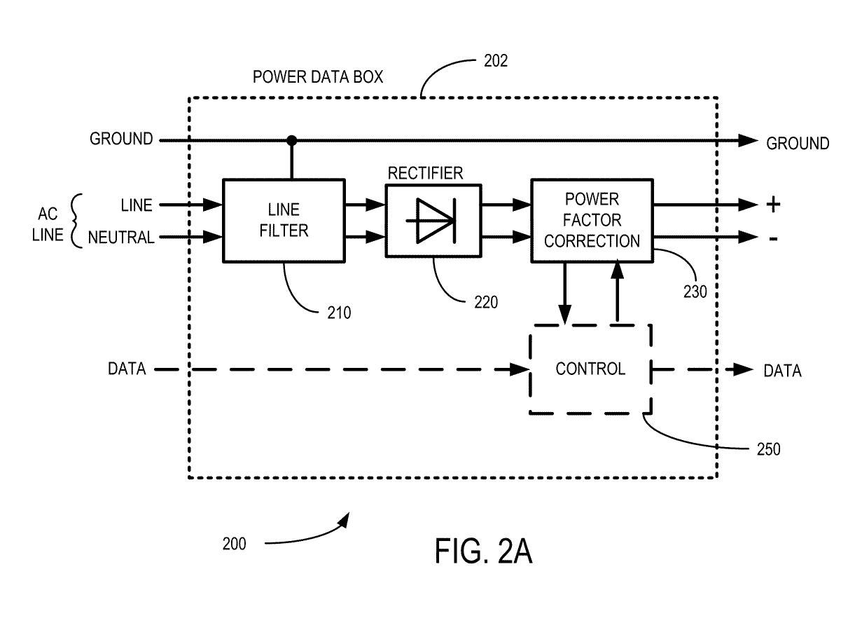

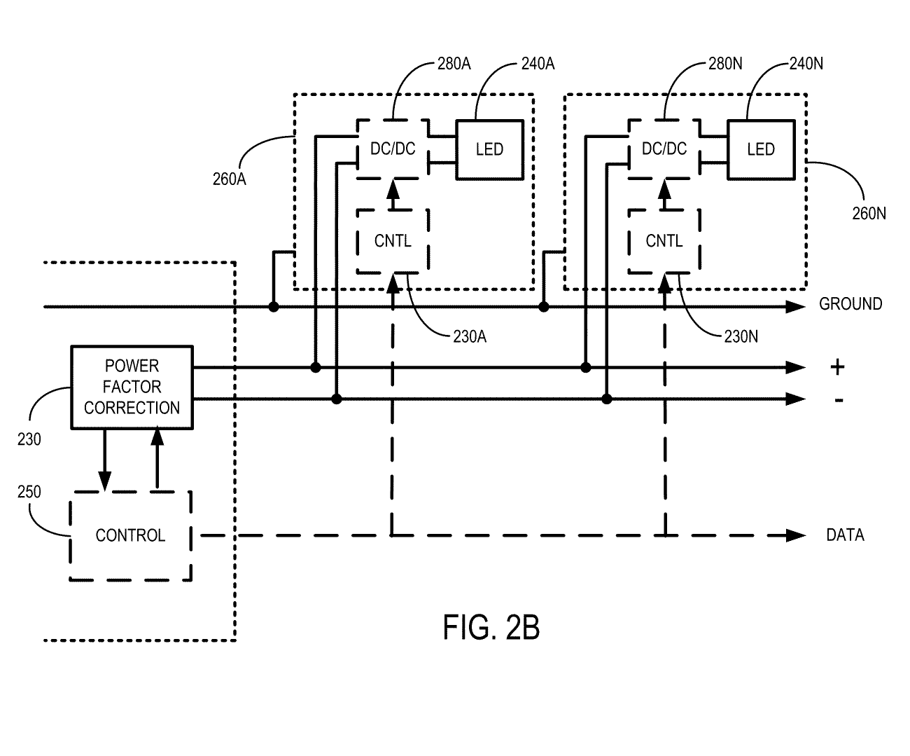

Now referring to FIGS. 2A and 2B, shown is an illustrative schematic block diagram of a DC LED lighting system 200 utilizing a power-data box in accordance with an embodiment. As shown in FIG. 2A, in an embodiment, the DC LED lighting system 200 includes a power-data box 202, which includes a line filter 210 connected to ground and to line and neutral of an AC line. Power data box 202 further includes a rectifier 220, a PFC module 230, and a control unit 250.

FIG. 2B shows PFC 230 and control 150 from FIG. 2A, and further shows ground, + and − lines from PFC 130, and data lines extending from power-data box 202. As shown in FIG. 2B, one or more luminares 260A . . . 260N are connected to ground, the + and − lines of PFC 130, and to the data line. More particularly, each LED module 260A . . . 260N includes individual LEDs 240A . . . 240N and an LED module control 230A . . . 230N adapted to receive data from main control unit 250. Each of the LED module controls 230A . . . 230N may be used to control the current and brightness of individual LEDs 240A . . . 240N, and may be collectively controlled via the main control unit 250 to generate various lighting patterns.

As shown in FIG. 2B, LED luminaires 260A . . . 260N need not contain individual PFCs 130 as in FIG. 1, as the LEDs 240A . . . 240N are connected to PFC module 230 in the main power data box 202. This significantly decreases the number of components required in LED modules 240A . . . 250N. Optional LED module controls 230A . . . 230N connected to optional DC/DC drivers 280A . . . 280N may be addressable to individually receive data from main control unit 250 or to receive data broadcast to all LED module controls 230A . . . 230N.

In an embodiment, the gauge or cross-section area of the conducting wires used to connect LED luminaires 260A . . . 260N may be selected much les than for conventional AC LED lighting system 100 (FIG. 1) due to the limited current, and output voltage from PFC 230 being significantly higher than AC line voltage used in conventional AC LED lighting system 100.

More preferably, the gauge of the conducting wires used to connect LED luminaires 260A . . . 260N may be selected to be between American Wire Gauge (AWG) AWG 24 and AWG 14, and the current may be limited between 5 and 30 Amps, such that the size of the LED luminaires 260A . . . 260N can be limited to desirably small dimensions.

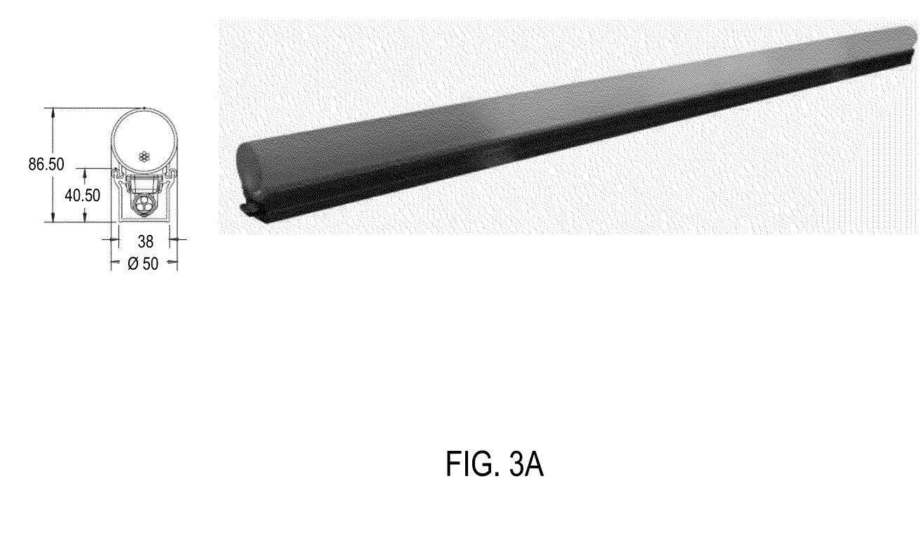

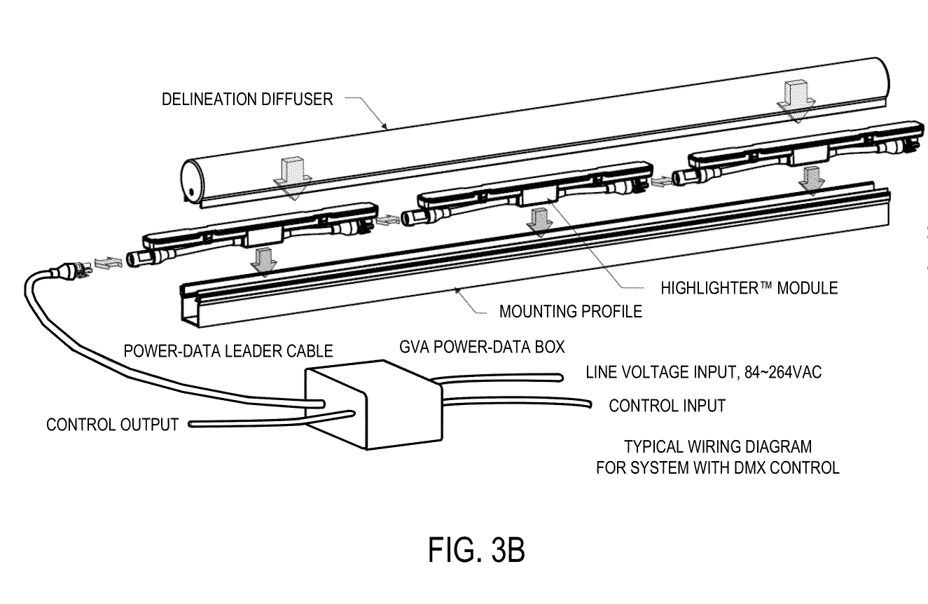

Most preferably, the gauge of the conducting wires used to connect LED luminaires 260A . . . 260N may be selected to AWG 18, and the current may be limited to 10 Amps, such that the size of the Luminares 260A . . . 260N can be limited for use in illustrative examples as shown in FIGS. 3-5 as described further below.

In an embodiment, power-data box 202 is adapted to supply a DC voltage significantly higher than conventional line voltage, in an operable range up to 430 VDC.

More preferably, power-data box 202 is adapted to supply a DC voltage between a range of 100 and 400 VDC, such that power-data box 202 can generate a sufficiently high level of power to supply power to individual LEDs 240A . . . 240N for significant lengths.

Most preferably, power-data box 202 is adapted to supply a DC voltage between a range of about 200 and 380 VDC, such that power-data box 202 can generate up to 3,800 Watts, which can be used to supply power to individual LEDs 240A . . . 240N rated at between about 1 and 100 Watts, connected at appropriate intervals depending on the Wattage of the LEDs 240A . . . 240N, over lengths of conductive wires extending 200 meters or more.

In an embodiment, Table 1 below shows possible lighting lengths in meters achievable when the power-data box 202 is capable of generating 2,000 Watts and 3,800 Watts and 5,000 Watts of power utilizing 110 VAC or 220-240 VAC input line voltages.

TABLE 1

| | | | | STR9-INF | |
|---|---|---|---|---|---|
| POWER- | INPUT | | HL- | 25 Watts/ | 50 Watts/ |
| DATA-BOX | VOLTAGE | HL-DL | COVE | meter | meter |
| PDB-2000 | 90-199 VAC | 110 | 110 | 39 | 20 |
| PDB-2000 | 200-264 VAC | 60 | 60 | 73 | 36 |
| PDB-3800* | 90-264 VAC | 201** | 201** | 142 | 72 |
| PDB-5000* | 90-264 VAC | 201** | 201** | 182 | 93 |

**For the color mixing version requiring three control channels to independently control three colors (for example red, green, and blue) version, the maximum length is 341 feet for 1 foot addressability (limited by DMX control universe, which can only address 241 three color pixes), full length for three channel control requires two DMX control universes.

Now referring to FIGS. 3A and 3B, shown are illustrative perspective views of one possible physical embodiment of the DC LED lighting system of FIGS. 2A and 2B. FIG. 3A illustrates a length of lighting which may include a number of lighting unit modules connected in series. As shown in FIG. 3B, three lighting unit modules are connected in series and covered by a delineation diffuser, which may be acrylic for example. A mounting profile, which may be aluminium for example, receives the three lighting unit modules and together with the delineation diffuser provides a protective, fully sealed IP66 300 millimeters (nominally 1 foot) luminaire with 18 LEDs. In use, each lighting unit module snaps into place in the aluminium profile, which is securely fastened to a mounting surface. The three lighting unit modules are connected end-to-end within the profile to create linear runs. The acrylic diffuse, with specialized light diffusing and UV stabilizing additives, installs to the profile, over the LED light modules. The diffuser conceals all mounting provisions, and provides a clean, uniform illuminated surface.

Still referring to FIG. 3B, a first end of the first lighting unit module is connected by a power-date leader cable to a power-data box shown in the foreground. The power-data box include a line voltage input, which may be between about 84-347 VAC. The power-data box also receives a control input line, and a control output leads out of the power-data box to be connected to the lighting unit modules in order to control the individual LED modules.

As shown in Table 2, below, this illustrative embodiment shown in FIGS. 3A and 3B allows exceptionally long runs of up to 201 meters with a single power and data feed from the power-data box.

TABLE 2
Specification Logic

| | | | | RUN |
|---|---|---|---|---|
| | | | | LENGTH |
| | MOUNTING | | | (IN |
| | PROFILE | LED | | METERS |
| FAMILY | COLOUR | COLOR | CONTROL | OR FEET)* |
| HL-DL | CM—Clear | RGB | ND—No Dimming | XXX |
| | Matts | 2700K | DMX—DMX | |
| | CUSTOM | 3000K | Control | |
| | | 3500K | DALI—DALI | |
| | | 4000K | Control | |
| | | 5000K | ARTNET— | |
| | | 6500K | ARTNET | |
| | | RD—Red | Control | |
| | | GR—Green | 0-10 V - 0-10 V | |
| | | BL—Blue | Dimming | |

* Length should be in 1 ft or 0.3 m increments
Sample Logic: HL-DL-CM-RGB-DMX-102M

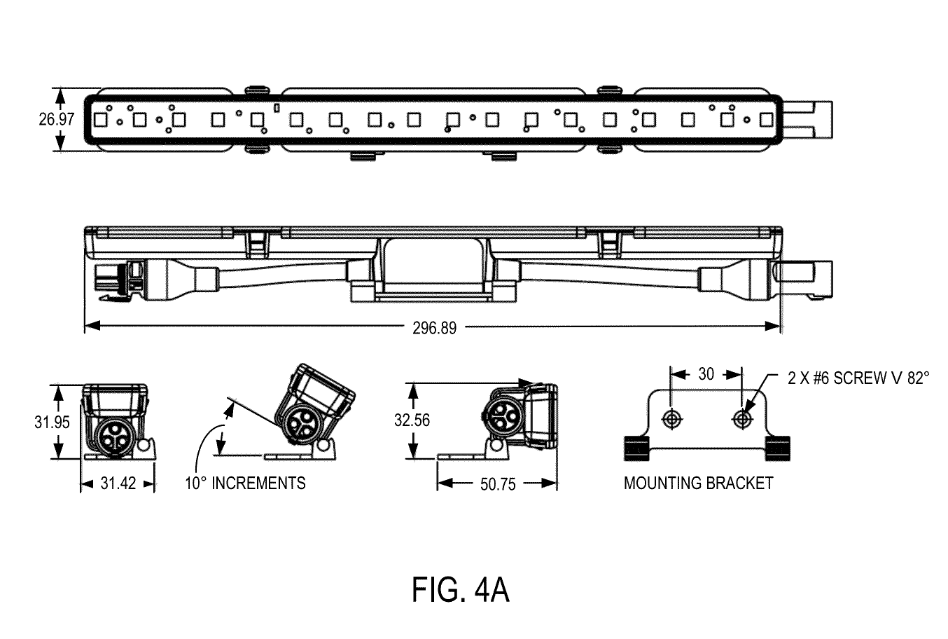

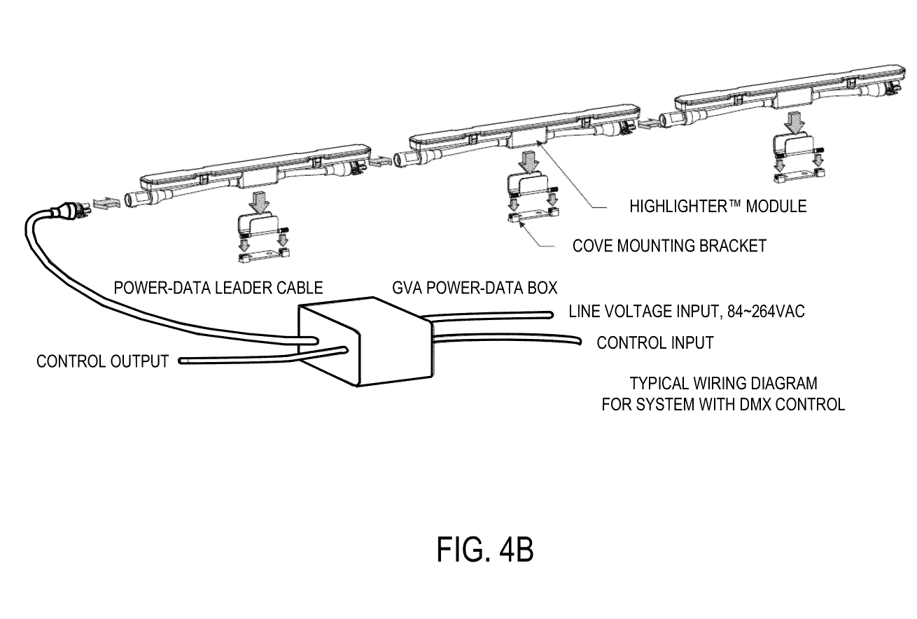

Now referring to FIGS. 4A and 4B, shown are illustrative plan views and perspective views of another possible physical embodiment of the DC LED lighting system of FIGS. 2A and 2B.

As shown in FIG. 4A, this illustrative embodiment comprises a long-run modular LED lighting system designed for cove lighting applications where it is impractical to have numerous power feed points. Typical applications include architectural cove lighting and delineation where long runs are necessary and limited power feeds are available. Exceptionally long runs of up to 201 meters are achievable with appropriate power-data-box.

In the present embodiment, the system consists of LED modules and corresponding mounting profiles. Each LED module is a fully sealed, IP66, 300 mm (1 foot) linear luminaire with 10 LEDS. Each module snaps into the mounting profile, which is securely fastened to the mounting surface. Modules are installed and connected end-to-end to create linear runs. Table 3, below, provides some illustrative LED lighting color and control specifications.

TABLE 3
Specification Logic

| | | | RUN LENGTH |
|---|---|---|---|
| | LED | | (IN METERS |
| FAMILY | COLOR | CONTROL | OR FEET)* |
| HL-COVE | RGB | ND—No Dimming | XXX |
| | 2700K | DMX—DMX Control | |
| | 3000K | DALI—DALI Control | |
| | 3500K | ARTNET—ARTNET Control | |
| | 4000K | 0-10 V - 0-10 V Dimming | |
| | 5000K | | |
| | 6500K | | |
| | RD—Red | | |
| | GR—Green | | |
| | BL—Blue | | |

* Length should be in 1 ft or 0.3 m increments
Sample Logic: HL-COVE-RGB-DMX-300FT

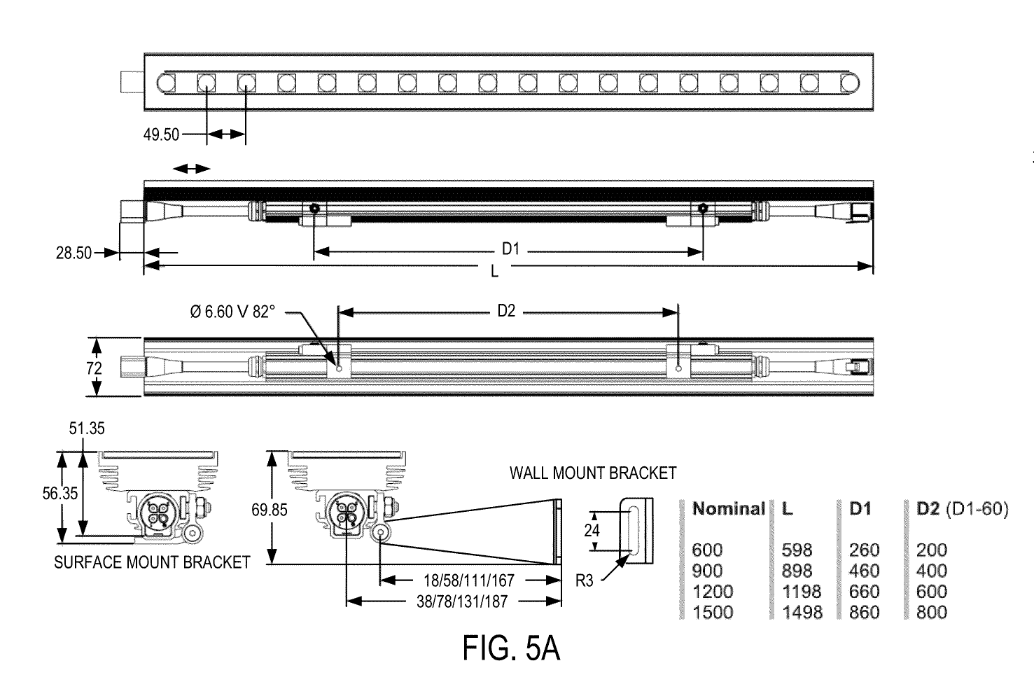

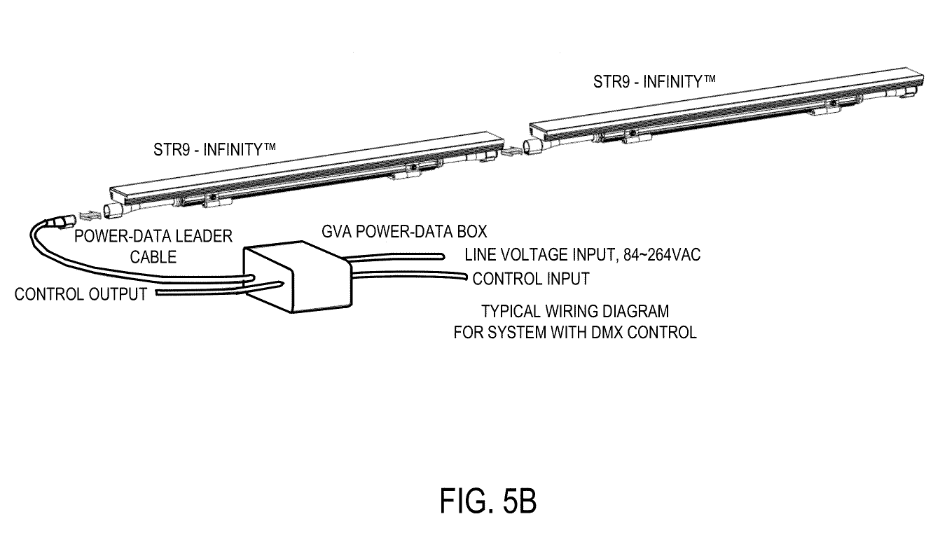

Now referring to FIGS. 5A and 5B, shown are illustrative plan views and perspective views of yet another possible physical embodiment of the DC LED lighting system of FIGS. 2A and 2B.

This illustrative embodiment is a high-power, long-run, linear LED luminaire designed for wall “washing”, wall “grazing” and cove lighting. Typical applications include “Architainment”, facade, bridge, airport, and shopping malls, particularly in large installations requiring long runs where multiple feeding points are not desirable or allowed. The system allows the LED modules to be connected end-to-end in exceptionally long runs (e.g. 182 meters at 25 Watt/meter consumption is achievable with a 5,000 W power-data-box. In an embodiment, IP68 rated connectors may be used to provide sealing even when unmated.

The LED modules are sealed to provide IP66 rated weatherproofing, and provides compact size, making it virtually invisible on the structure to which it is installed. The thermal design is effective in hot and humid climates as well as severe northern winters. Table 4, below, shows

TABLE 4
Specification Logic

| | | | LED | | | | | | |
|---|---|---|---|---|---|---|---|---|---|
| | | | QTY. PER | | | | | | |
| | NOMINAL | BODY | 300 MM/ | LED | LED | | | VOLT- | |
| FAMILY | LENGTH | COLOR | 1 FT. | POWER | COLOR | OPTICS | CONTROL | AGE | MOUNTING |
| STR9- | 600 | CM—Clear | 6 | 1 W | 2700K | TD—Tight Beam | ND—No | 380 VDC | SM—Surface |
| INF | | Matte | | | | (8° FWHM) | Dimming, | | Mount |
| | | | | | | | On/Off | | Adjustable |
| | 900 | BM—Black | | 2.3 W | 3000K | NB—Narrow Beam | ZH—GVA | 24 VDC | W35—Wall |
| | | Matte | | | | (12° FWHM) | Protocol | | Mount Adjustable |
| | | | | | | | ZH | | 38 mm |
| | 1200 | | | | 3500K | MB—Medium | | 48 VDC | W78—Wall |
| | | | | | | Beam (20° FWHM) | | | Mount Adjustable |
| | | | | | | | | | 78 mm |
| | 1300 | | | | 4000K | WB—Wide Beam | | | W121—Wall Mount |
| | | | | | | (54° FWHM) | | | Adjustable 131 mm |
| | 1800 | | | | 5000K | FB—Flood Beam | | | W187—Wall Mount |
| | | | | | | (70° FWHM) | | | Adjustable 187 mm |

| | | | |
|---|---|---|---|
| 2100 | 6300K | EB—Elliptical | Sample Logic: STR9-INF-1500-CM-6- |
| | | Beam | 2WT-3000K-NB-ZH-380VDC |
| | | (12° × 46° FWHM) | |
| 2400 | RD—Red | AN—Asymmetrical | |
| | | Narrow | |
| | RO—Red- | AE—Asymmetrical | |
| | Orange | Elliptical | |
| | AM—Amber | | |
| | GR—Green | | |
| | BL—Blue | | |
| | RB—Royal | | |
| | Blue | | |

While various illustrative embodiments have been described, it will be appreciated that various modifications and changes may be made without departing from the scope of the invention.

1. A power distribution system for light emitting diode (LED) lighting, comprising:
a line filter configured to receive an alternating current (AC) line voltage;
a rectifier for converting the AC line voltage into a direct current (DC) voltage; and
a power factor corrector (PFC) configured to output a DC voltage greater than peak AC line voltage, and wherein the PFC configured to supply the DC voltage directly to a plurality of LED luminaires remotely connected to the PFC by conductor wires.

2. The power distribution system of claim 1, wherein the conductor wires are selected to have a cross-sectional area between about 2 mm² and 0.1 mm² suitable for direct current in a range of about 5 Amperes and 30 Amperes.

3. The power distribution system of claim 2, wherein the conductor wires are between American Wire Gauge (AWG) 24 and AWG 14.

4. The power distribution system of claim 2, wherein the line filter, rectifier, and PFC are configured to generate a DC voltage between higher than peak AC line input and 750 VDC.

5. The power distribution system of claim 1, wherein the conductor wire is American Wire Gauge (AWG) 18 suitable for direct current up to about 10 A.

6. The power distribution system of claim 5, wherein the line filter, rectifier, and PFC are configured to generate a DC voltage between about 200 VDC and 380 VDC.

7. The power distribution system of claim 6, wherein the line filter, rectifier, and PFC are configured to supply up to about 3800 Watts of power over an extended conductor length of over 30 meters.

8. The power distribution system of claim 1, further comprising a control module for controlling the plurality of LED luminares:

9. The power distribution system of claim 8, further comprising a data line for connecting the control module to a control unit in each remote LED luminaire.

10. The power distribution system of claim 9, further comprising a DC/DC driver in each LED luminaire configured to be controlled by the control unit in each remote LED luminaire.

11. A power distribution method for light emitting diode (LED) lighting, comprising:
providing a line filter configured to receive an AC line voltage;
providing a rectifier for converting the AC line voltage into a DC voltage; and
a configuring a power factor corrector (PFC) to output a DC voltage greater than peak AC line voltage, and wherein the PFC configured to supply the DC voltage directly to a plurality of LED luminaires remotely connected to the PFC by conductor wires.

12. The power distribution method of claim 11, further comprising selecting the conductor wires to have a cross-sectional area between about 2 mm2 and 0.2mm2 suitable for direct current in a range of about 5 A and 30 A.

13. The power distribution method of claim 12, wherein the conductor wires are between American Wire Gauge (AWG) 24 and AWG 14.

14. The power distribution method of claim 12, wherein the line filter, rectifier, and PFC are configured to generate a DC voltage between higher than peak AC line input and 750 VDC.

15. The power distribution method of claim 12, wherein the conductor wire is American Wire Gauge (AWG) 18 suitable for direct current up to about 10 A.

16. The power distribution method of claim 15, wherein the line filter, rectifier, and PFC are configured to generate a DC voltage between about 200 VDC and 380 VDC.

17. The power distribution method of claim 16, wherein the line filter, rectifier, and PFC are configured to supply up to about 3800 Watts of power over an extended conductor length of over 30 meters.

18. The power distribution method of claim 11, further comprising providing a control module for controlling the plurality of LED luminares:

19. The power distribution method of claim 18, further comprising providing a data line for connecting the control module to a control unit in each remote LED luminaire.

20. The power distribution method of claim 19, further comprising a DC/DC driver in each LED luminaire configured to be controlled by the control unit in each remote LED luminaire.
